(19) United States
(12) Patent Application Publication
(10) Pub. No.: US 2025/0299003 A1
(43) Pub. Date: Sep. 25, 2025

(54) METHOD FOR MONITORING HEALTH OF ROBOT AND HEALTH MONITORING SYSTEM FOR ROBOT

(71) Applicant: ABB SCHWEIZ AG, Baden (CH)

(72) Inventor: Jiafan Zhang, Shanghai (CN)

(21) Appl. No.: 19/229,340

(22) Filed: Jun. 5, 2025

Related U.S. Application Data
(63) Continuation of application No. PCT/CN2022/136669, filed on Dec. 5, 2022.

(51) Int. Cl. G06K 7/14; B25J 9/16

(52) U.S. Cl. CPC G06K 7/1417; B25J 9/1674

(57) ABSTRACT

Embodiments of present disclosure provide a method for monitoring health of robot and a health monitoring system for the robot. The method comprises: obtaining measured data associated with health condition of the robot; generating a 2-dimensional, 2D, bar code based on the measured data, the 2D bar code comprising information associated with the health condition of the robot; and displaying the 2D bar code on a displayer. The embodiments of the present disclosure can reduce or eliminate sensitive data leakage and other cyber security issues for the robot system and improve user experience.

### FIELD

Embodiments of present disclosure generally relate to the technical field of robots, and more particularly, to a method for monitoring health of a robot and a health monitoring system for the robot.

### BACKGROUND

An industrial robot generally refers to the mechanical apparatus with one or more joints or freedom degrees. The robots are widely used in various industrial fields for realizing automatic processing and manufacturing. During the automatic processing and manufacturing, the abnormity or fault of robots will lead to unqualified products or production stoppage and delay, thus resulting in economic losses. Therefore, robot maintenance, specifically predictive maintenance, is needed and important.

For the robot maintenance, it is necessary to monitor the operation and health condition of the robots regularly. However, how to successfully collect the robot running data on-site is always challenging due to several issues, for example, concerns from customers on their production sensitive data, connection of controller, cyber security, etc.

### SUMMARY

Embodiments of the present disclosure provide a method for monitoring health of a robot and health monitoring system for the robot.

In a first aspect, a method for monitoring health of a robot is provided. The method comprises: obtaining measured data associated with health condition of the robot; generating a 2-dimensional, 2D, bar code based on the measured data, the 2D bar code comprising information associated with the health condition of the robot; and displaying the 2D bar code on a displayer, such as a teach pendant unit (TPU), which is connected to the robot controller.

In some embodiments, generating the 2D bar code based on the measured data comprising: generating, based on the measured data, at least one indicator value at a predefined time interval, the at least one indicator value indicating the health condition of the robot; and in response to a user request, generating the 2D bar code comprising the latest at least one indicator value.

In some embodiments, the 2D bar code further comprises at least one of identification information of the robot and time information.

In some embodiments, the 2D bar code comprises Quick Response code.

In a second aspect, a method for monitoring health of a robot is provided. The method comprises: scanning a 2-dimensional, 2D, bar code displayed on a displayer of a control device of the robot; decoding the 2D bar code to obtain information associated with health condition of the robot; and transmitting the information associated with the health condition of the robot to a server.

In some embodiments, the 2D bar code comprises website information of the server, and wherein the method further comprises: accessing the server according to the website information after decoding the 2D bar code.

In some embodiments, the method further comprising: receiving assessment result for the health of the robot from the server.

In a third aspect, a method for monitoring health of a robot is provided. The method comprises: receiving information associated with health condition of the robot from a user device; assessing the health of the robot based on the information associated with the health condition of the robot; and transmitting the assessment result to the user device.

In some embodiments, the method further comprising: determining when the robot will fall into an unhealthy state based on the historical information associated with the health condition of the robot; and transmitting the determined information to the user device.

In some embodiments, the method further comprising: determining a time length since assessment result was last transmitted to the user device; and in response to the time length exceeding a time threshold, transmitting a reminder information to the user device.

In some embodiments, the method further comprising: comparing health related data of robot with health related data of robots used at further users or in further applications, and transmitting suggestion information generated based on the comparison to the user device to improve the operation of the robot.

In a fourth aspect, a control device for a robot is provided. The control device comprises: a displayer; a controller, configured to: obtain measured data associated with health condition of the robot; and generate a 2-dimensional, 2D, bar code based on the measured data, the 2D bar code comprising information associated with the health condition of the robot; and display the 2D bar code on the displayer.

In some embodiments, the controller is further configured to: determine, based on the measured data, at least one indicator value at a predefined time interval, the at least one indicator value indicating the health condition of the robot; and in response to a user request, generate the 2D bar code comprising the latest at least one indicator value.

In some embodiments, the 2D bar code further comprises at least one of identification information of the robot and time information.

In some embodiments, the 2D bar code comprises Quick Response code.

In a fifth aspect, a user device is provided. The user device comprises: at least one photoelectric sensor configured to scan a 2-dimensional, 2D, bar code displayed on a displayer of a control device for a robot; at least one processing unit; and at least one memory coupled to the at least one processing unit and storing instructions executable by the at least one processing unit, the instructions, when executed by the at least one processing unit, causing the device to: decode the 2D bar code to obtain information associated with the health condition of the robot; and transmit the information associated with the health condition of the robot to a server.

In some embodiments, the 2D bar code further comprising website information of the server, and wherein the instructions, when executed by the at least one processing unit, further causes the device to: access the server according to the website information after decoding the 2D bar code.

In some embodiments, the instructions, when executed by the at least one processing unit, further causes the device to: receive assessment result for the health of the robot from the server.

In a sixth aspect, a server is provided. The server comprises: at least one processing unit; and at least one memory coupled to the at least one processing unit and storing instructions executable by the at least one processing unit, the instructions, when executed by the at least one processing unit, causing the server to: receive information associated with health condition of a robot from a user device; assess the health of the robot based on the information associated with the health condition of the robot; and transmit the assessment result to the user device.

In some embodiments, the instructions, when executed by the at least one processing unit, further causing the server to: determine when the robot will fall into an unhealthy state based on the historical information associated with the health condition of the robot; and transmit the determined information to the user device.

In some embodiments, the instructions, when executed by the at least one processing unit, further causing the server to: determine a time length since assessment result was last transmitted to the user device; and in response to the time length exceeding a time threshold, transmit a reminder information to the user device.

In some embodiments, the instructions, when executed by the at least one processing unit, further causing the server to: compare health related data of robot with health related data of robots used at further users or in further applications, and transmit suggestion information generated based on the comparison to the user device to improve the operation of the robot.

In a seventh aspect, a health monitoring system for a robot is provided. The health monitoring system comprises: the control device of the robot according to the fourth aspect; the user device according to the fifth aspect; and the server according to the sixth aspect.

### DESCRIPTION OF DRAWINGS

Drawings described herein are provided to further explain the present disclosure and constitute a part of the present disclosure. The example embodiments of the disclosure and the explanation thereof are used to explain the present disclosure, rather than to limit the present disclosure improperly.

FIG. 1 illustrates a schematic diagram of a robot and a control device in accordance with an embodiment of the present disclosure.

FIG. 2 illustrates a flowchart of a method for monitoring the health of the robot in accordance with an embodiment of the present disclosure.

FIG. 3 illustrates a schematic diagram of a user device and a server in accordance with an embodiment of the present disclosure.

FIG. 4 illustrates a flowchart of a method for monitoring the health of the robot in accordance with an embodiment of the present disclosure.

FIG. 5 illustrates a flowchart of a method for monitoring the health of the robot in accordance with an embodiment of the present disclosure.

FIG. 6 illustrates a graph of historical diagnosis data and predicted data of the robot in accordance with an embodiment of the present disclosure.

FIG. 7 illustrates an another graph of historical diagnosis data the robot in accordance with an embodiment of the present disclosure.

FIG. 8A illustrates a flowchart of procedure of providing robot fault prediction in accordance with an embodiment of the present disclosure.

FIG. 8B illustrates a flowchart of procedure of providing reminder information in the case of no health check for a long time in accordance with an embodiment of the present disclosure.

FIG. 8C illustrates a flowchart of procedure of providing suggestion information in accordance with an embodiment of the present disclosure.

FIG. 9 illustrates a schematic block diagram of an example device adapted to implement embodiments of the present disclosure.

Throughout the drawings, the same or similar reference symbols are used to indicate the same or similar elements.

### DETAILED DESCRIPTION OF EMBODIEMTNS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

Unless specified or limited otherwise, the terms “mounted,” “connected,” “supported,” and “coupled” and variations thereof are used broadly and encompass direct and indirect mountings, connections, supports, and couplings. Furthermore, “connected” and “coupled” are not restricted to physical or mechanical connections or couplings. In the description below, like reference numerals and labels are used to describe the same, similar or corresponding parts in the figures. Other definitions, explicit and implicit, may be included below.

As discussed above, in conventional solutions, there are some issues in collecting the robot operation data on-site. For example, the robot controller in some solutions, such as Remote-Service from ABB and ZDT (Zero-Downtime) from Fanuc, is communicatively in connection with an external network or a remote server for providing the collected operation data and determining the health of the robot. However, such connection may lead to leakage of production or manufacturing data and other cyber security issues.

According to embodiments of the present disclosure, a 2D bar code containing information associated with the health condition of a robot is generated and displayed on a displayer of the control device of the robot. In this way, according to the maintenance requirements for robots, the operation data of the robot can be present on the displayer and obtained by a user device and a server, and thus the control device of the robot does not need to be connected to the external network or device in either a wireless or wired manner, thereby reducing and eliminating the leakage of sensitive data and other cyber security issues.

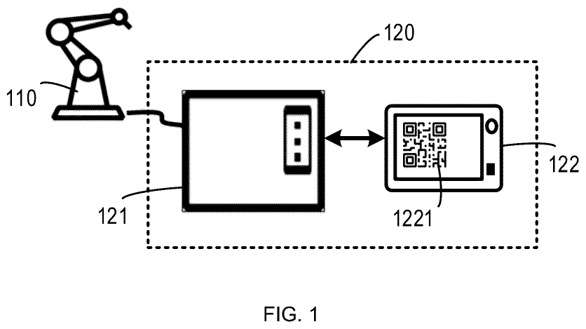

FIG. 1 illustrates a schematic diagram of a robot 110 and a control device 120 in accordance with an embodiment of the present disclosure. The robot 110 may be an industrial robot with one or more joints or freedom degrees, and the control device 120 is used for controlling the operation of the robot 110. For example, the robot 110 can carry out predefined motion or operation according to program instructions preset and stored in the control device 120, and the speed, position and acceleration of the effector of the robot 110 in its motion can be properly controlled by the control device 120. The control device 120 comprises a controller 121 and a displayer 122. For example, the displayer 122 may be a teach pendant unit, or a part of the teach pendant unit, and can communicate with the controller 121 in a wireless or wired manner. In some examples, the teach pendant unit may comprise one or more control units, which can perform data processing or the similar operations as the controller 121, and in this case, these control units in the teach pendant unit may be regarded as a part of the controller 121. By means of the teach pendant unit or the displayer 122, an operator can interact with the controller 121 or the control device 120. For example, the operator may input the program instructions associated with the operation of the robot 110 into the control device 120, so that the robot 110 can be operated in a desired manner.

Furthermore, sensing devices (not shown in FIG. 1) or any other devices for sensing or detecting the motion of the robot 110 can be mounted on or near the robot 110, and can provide measured data to a controller 121 of the control device 120. These sensing devices include, but are not limited to, force sensors, pressure sensors, angle sensors, position sensors, speed sensors, acceleration sensors, vision sensors, and any other suitable sensors.

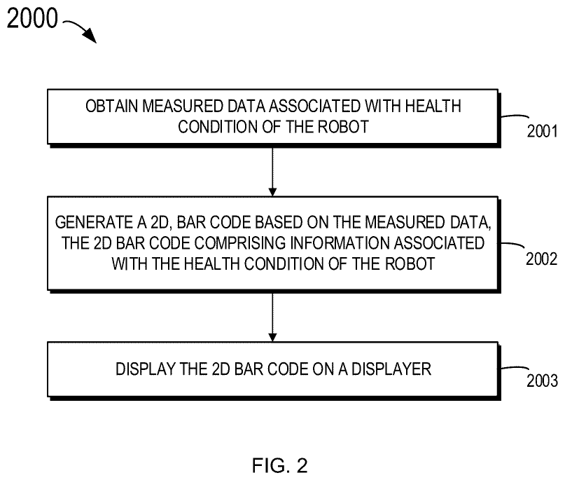

FIG. 2 illustrates a flowchart of a method 2000 for monitoring the health of the robot 110 in accordance with an embodiment of the present disclosure. The method 2000 may be implemented by controller 121 of the control device 120 as described above. For discussion, the method 2000 will be described below with reference to FIG. 1.

At block 2001, the controller 121 obtains measured data associated with health condition of the robot 110. For example, the controller 121 can collect or receive the measured data from the sensing devices mounted on or near the robot 110. The measured data include, for example, the position, speed and acceleration of the robot 110 in operation, or other data which reflects the health condition of the robot 110.

At block 2002, the controller 121 generates a 2-dimensional, 2D, bar code 1221 based on the measured data, the 2D bar code 1221 comprising information associated with the health condition of the robot. Specifically, on the basis of the measured data associated with health condition of the robot 110, the controller 121 may generate a 2D bar code 1221. The 2D bar code 1221 contains a binary code in black and white squares, which contains information related to the health of the robot that needs to be provided to the outside for assessment. In an embodiment, the 2D bar code 1221 comprises Quick Response, QR, code. The QR code has the advantages of large information storage capacity, support for numbers and a variety of letters, and strong error correction capability. Alternatively, the 2D bar code may also be other type, e.g., Data Matrix, Maxi code, Aztec code, Vericode, PDF417, Ultracode, Code 49, Code 16K, Code one, Han Xin code, etc. In an embodiment, the 2D bar code further comprises at least one of identification information of the robot and time information. Specifically, the 2D bar code may further contain some further necessary information, including identification information of the robot, e.g., series number of the robot, time information, e.g., the time when the 2D bar code was generated or other relevant times and any other information which facilitate monitoring of the robot health.

At block 2003, the controller 121 displays the 2D bar code 1221 on the displayer 122. Specifically, the generated 2D bar code 1221 can be shown by the displayer 122 to the operator or user as required. For example, when the health condition of the robot needs to be checked, the user or the operator can trigger the controller 121 and the displayer 122, e.g., by inputting a request, and then the generated 2D bar code with information of the robot health condition may be present or shown on the displayer 122. In this way, the data related to the robot health in the control device 120 may be provided to external devices for assessment and monitoring without establishing a communication connection, thereby alleviating and eliminating the leakage risk of production or manufacturing data and other cyber security problems due to the wireless and wired communication connections.

In some embodiments, the controller 121 generates, based on the measured data, at least one indicator value at a predefined time interval, the at least one indicator value indicating the health condition of the robot 110, and in response to a user request, the controller 121 generates the 2D bar code comprising the latest at least one indicator value. As an example, the controller 121 may perform a regular diagnosis check in a predefined frequency or at a predefined time interval. The frequency or time interval may be set or configured by the operator or user, e.g. via the teach pendant unit. In the regular diagnosis check, the controller 121 collects the measured data while the robot 110 is in motion or operation, and processes and calculates the collected data. Through processing and calculation, one or more indicator values indicating the health condition of the robot 110 can be derived from the collected data, and can be stored in the controller 110. When the operator wants to check the robot health, he or she can initiate a request to the displayer 122 or the controller 121 in a proper manner, e.g., the operator can click an App on the teach pendant unit. Then, in response to the request, the controller 121 will read the most recent indicator values stored in the controller 121, and the read indicator values compose the 2D bar code with other optional information.

In this way, when the user need to perform regular health check on the robot 110, the control device 120 can immediately read the latest robot data, thereby presenting the required robot data in the form of the 2D bar code without delay. Moreover, the information capacity of the 2D bar code is limited, and the amount of measured data may be very large and exceed the upper limit of capacity of the 2D bar code. Therefore, by preprocessing and calculating the measured data, the amount of data can be reduced to within the information capacity of the 2D bar code. Furthermore, an another benefit of preprocessing the measured data is that since the measured data of the robot 110 involve the production data or manufacturing data which are usually sensitive, the preprocessing of the measured data in the control device 120 can eliminate the potential risk of sensitive data leakage.

Furthermore, it is noted that the above processing and calculation of the measured data in the control device 120 is not necessary in some cases. For example, if the measured data is not sensitive and its data amount is below the upper capacity limit of the 2D bar code, the measured data can be directly used to form the 2D bar code without preprocessing.

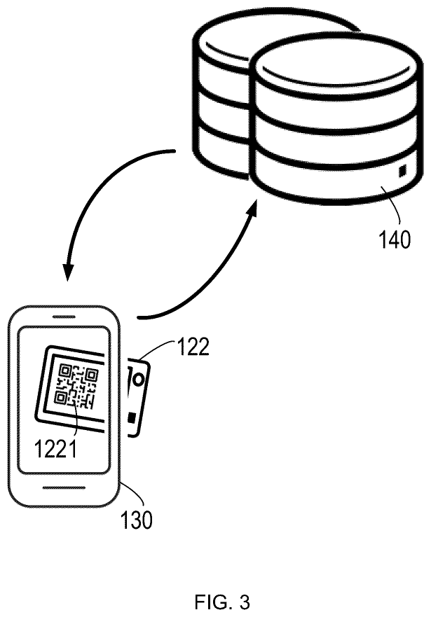

FIG. 3 illustrates a schematic diagram of a user device 130 and a server 140 in accordance with an embodiment of the present disclosure. The user device 130 comprises at least one photoelectric sensor, and with the photoelectric sensor, at least the black and white squares in the 2D bar code can be sensed and identified by the user device 130. Moreover, the user device 130 can communicate with the sever 140. For example, both of the user device 130 and the server 140 can access a wide area access (WAN) such as Internet, a local access network (LAN), or other type of the network, so that data may be transmitted from the user device 130 to the server 140 or from the server 140 to the user device 130 via the network. Alternatively, the user device 130 can be directly connected to the server 140 through point-to-point wireless communication such as Zigbee and Bluetooth. In some cases, the user device 130 may be connected to the server 140 through wired communication. The embodiments of the present disclosure do not impose any limitation on the communication manner between the user device 130 and the server 140.

By way of example only, the user device 130 may be a smart phone with a camera. However, it is appreciated that the user device 130 may be any other type of an electronic device, which includes, but is not limited to, a laptop computer, a tablet computer, a camera, a netbook, a smartbook, an ultrabook, a personal digital assistant (PDA), a wearable device such as a smart watch, smart clothing, smart glasses and a smart wrist band, or any other suitable device that is provide with photoelectric sensor(s) and configured to communicate via a wireless or wired medium. Furthermore, in some cases, the user device 130 may also be a combination of a 2D bar code scanner and an electronic device, wherein the electronic device is detachably coupled to the 2D bar code scanner and does not be equipped with any photoelectric sensing component. By way of example only, the server 140 may be a service center. However, it is appreciated that the server 130 may be other suitable type of a computing or processing apparatus, e.g., a cloud server, an industrial computer, etc.

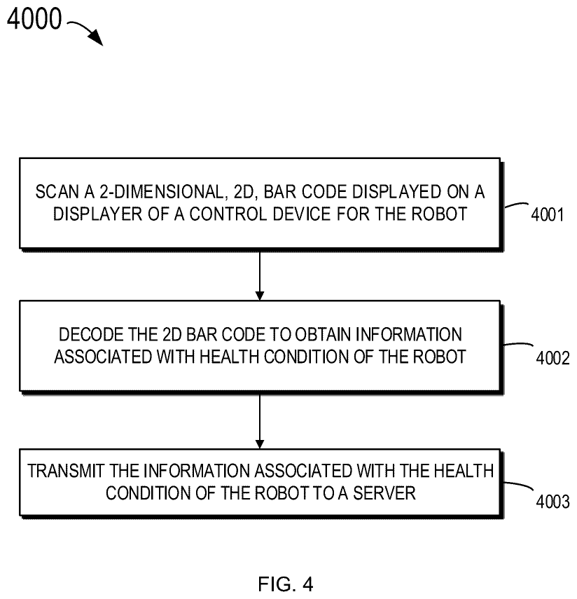

FIG. 4 illustrates a flowchart of a method 4000 for monitoring the health of the robot 110 in accordance with an embodiment of the present disclosure. The method 4000 may be implemented by the user device 130 as described above. For discussion, the method 4000 will be described below with reference to FIG. 3.

At block 4001, the user device 130 scans the 2D bar code 1221 displayed on the displayer 122 of a control device 120 for the robot 110. For example, the operator may click a 2D bar code scanning App in the smart phone (i.e., the user device 130), and use the camera in the smart phone to scan or capture the 2D bar code presented on the displayer 122 of the control device 120, which code at least contains information related to the health condition of the robot 110.

At block 4002, the user device 130 decodes the 2D bar code 1221 to obtain information associated with the health condition of the robot 110. For example, the 2D bar code 1221 may be decoded by the smart phone, and thus the information including the information or the indicator values of the robot health condition and other optional information (e.g., the series number of the robot and the time when the 2D bar code was generated) is obtained.

At block 4003, the user device 130 transmits the information associated with the health condition of the robot 110 to the server 140. For example, the user device 130 can be connected to the server, e.g., ABB service center, after registration or log in. Then, the smart phone may send the decoded information of the 2D bar code to the server 140 directly or via a network. As a result, the information in the 2D bar code provided by the control device 120 is finally transferred to the server 140 for further assessment. In this way, the required monitoring information can be reliably transferred from the robot control device 120 to the server 140, and no network-related hardware is needed in the robot control device 120, which reduce setup complexity of the robot system and make it user-friendly. Moreover, more importantly, using the 2D bar code and the user device 130 to transfer robot Monitor data can reduce or even eliminate the concerns from the users on the data sensitivity.

In some embodiments, the 2D bar code comprises website information of the server 140, and after decoding the 2D bar code, the user device 130 accesses the server 140 according to the website information. Specifically, the website information (e.g., Uniform Resource Locator, URL) of the server 140 can be provided to the control device 120 in advance, and thus the website information can form the 2D bar code 1221 with other information described above. As the user device 130 scans and decodes the 2D bar code 1221 displayed on the displayer 122, the user device 130 can obtain URL of the server 140 and automatically access the server 140, which removes the need to provide a dedicated App in the user device 130 or to preset the web address of the accessed server in the user device 130.

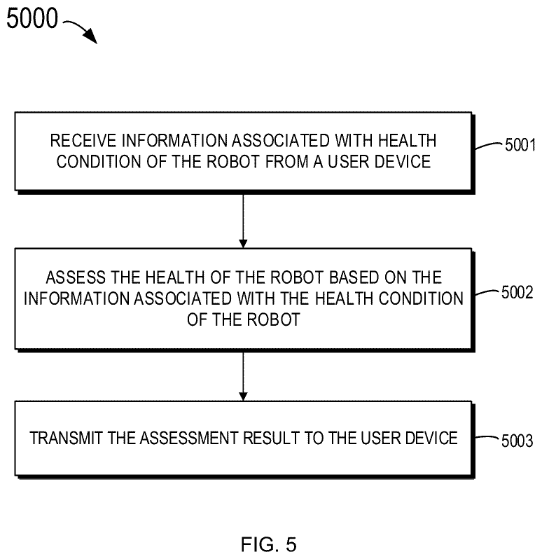

FIG. 5 illustrates a flowchart of a method 5000 for monitoring the health of the robot 110 in accordance with an embodiment of the present disclosure. The method 5000 may be implemented by the server 140 as described above. For discussion, the method 5000 will be described below with reference to FIG. 3.

At block 5001, the server 140 receives information associated with the health condition of the robot 110 from the user device 130. Specifically, as the connection between the user device 130 and the server 140 is established, the decoded information described in the method 4000 can be transferred from the user device 130 to the server 140.

At block 5002, the server 140 assesses the health of the robot 110 based on the information associated with the health condition of the robot 110. For example, based on the received data and information, the server 140 may assess the health of the robot 110 according to the predefined assessment criteria. In an example, the server 140 can use specific models or algorithms to process data. Through analysis and evaluation, the server 140 can determine whether the robot 110 is healthy or unhealthy.

At block 5003, the server 140 transmits the assessment result to the user device 130. Accordingly, the user device 130 receives the assessment result for the health of the robot from the server 140. Specifically, by means of the connection between the server 140 and the user device 130, the assessment result is sent to the user device 130, e.g., the smart phone of the user. In this way, the on-site user or operator will know the health of the robot and whether the maintenance is needed within a short time after scanning the 2D bar code 1221. Moreover, since the assessment is performed and sent by the server 140, no pre-defined assessment criteria are necessary to embedded in the control device 120 before the robot 110 and its control device 120 are released to the customers, which enables the case of criteria refining, thereby reducing the risk in mis-alarm and false-alarm of the robot fault.

Furthermore, the solution of monitoring the health of the robot according to the present disclosure may further provide extensive extended service to the users, which can further improve the experience of users during the use of the robot system. The extended services will be described in detail below.

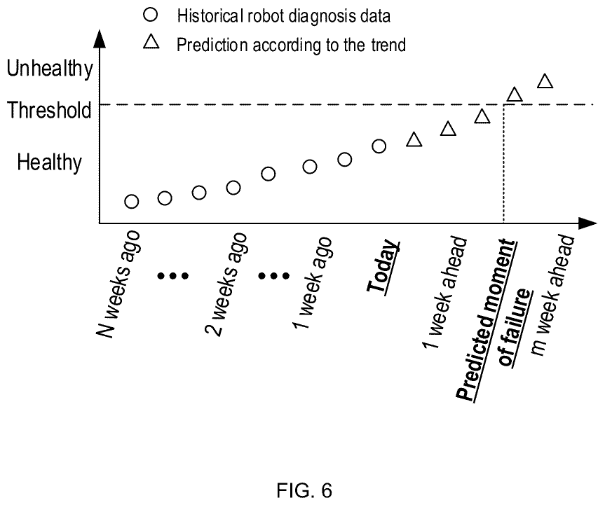

FIG. 6 illustrates a graph of historical diagnosis data and predicted data of the robot 110 in accordance with an embodiment of the present disclosure. As shown in FIG. 6, the server 140 determines when the robot 110 will fall into an unhealthy state based on the historical information associated with the health condition of the robot 110. For example, historical data (indicated by circles in the graph of FIG. 6) in the past N weeks can be stored in the server 140, and based on the historical data, the server 140 can predict the data change trend (indicated by triangles in the graph of FIG. 6) of the robot 110 in the next few days or weeks. Furthermore, a threshold for the health related data is predefined in the server 140. By comparing the predicted data with the threshold, the moment when the robot will fall into the unhealthy state can be determined. Then, the server 140 transmits the determined information to the user device 130. For example, the determined information may include the predicted moment of the robot failure and some suggestions, e.g., “Based on the historical health check data of your robot, it seems to be out of work in a few days” and “We suggest you contact ABB service center as soon as possible”. In this way, the notice about the risk of robot failure can be provided to the user in advance according to the degradation trend, and thus the user can arrange maintenance according to the risk, so as to avoid interruption of production due to robot downtime.

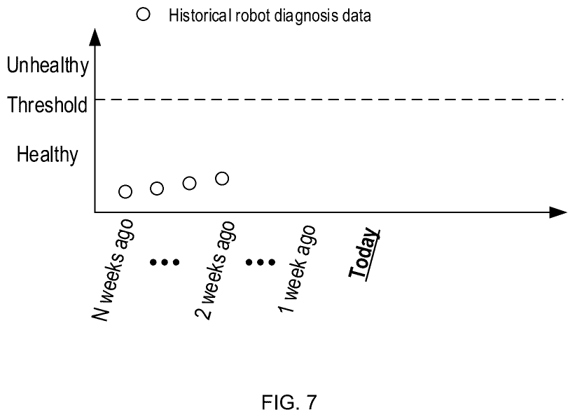

FIG. 7 illustrates an another graph of historical diagnosis data the robot 110 in accordance with an embodiment of the present disclosure. As shown in FIG. 7, the server 140 determines a time length since assessment result was last transmitted to the user device 130. Specifically, the server 140 can determine the time or date when the robot health assessment was last performed, e.g., two weeks ago, thereby determining how long the robot health assessment has not been performed. Then, the server 140 can compare the determined time length with a time threshold, and if the determined time length exceeds the time threshold, the server 140 transmits a reminder information to the user device 130. For example, the reminder information may comprise the date or time of last assessment and some suggestions, e.g., “We find you have not done health check for your robot in last month” and “We suggest you can do a check of your robot health condition”. In this way, the robot can be prevented from downtime due to lack of health check for a long time, thereby reducing the possibility of unexpected downtime.

Furthermore, in some embodiments, the server 140 compares health related data of robot 110 with health related data of robots used at further users or in further applications, and the server 140 transmits suggestion information generated based on the comparison to the user device 130 to improve the operation of the robot 110. For example, there may be further users and applications similar to the user and application of the robot 110, and the good and bad operating habits for the robots of these users and applications can be used for reference by the users of robot 110. In this way, the operation of the robot can be improved, thereby reducing the possibility of robot failure and prolonging the service life of the robot.

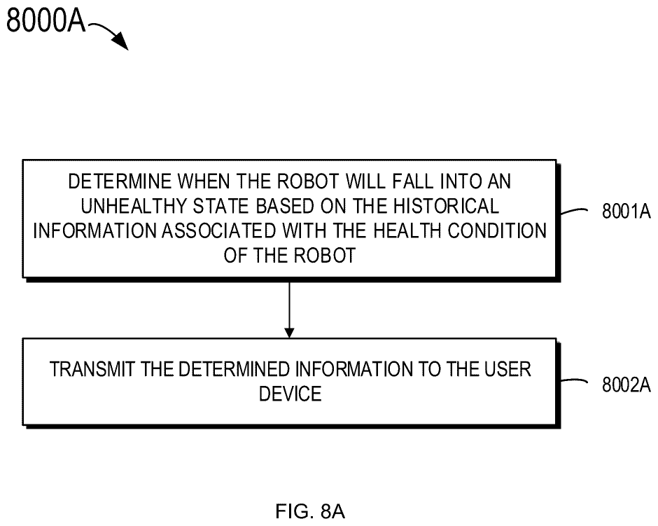

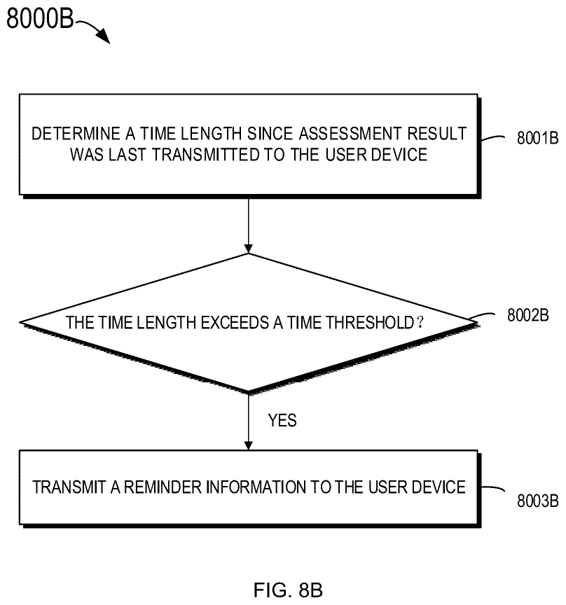

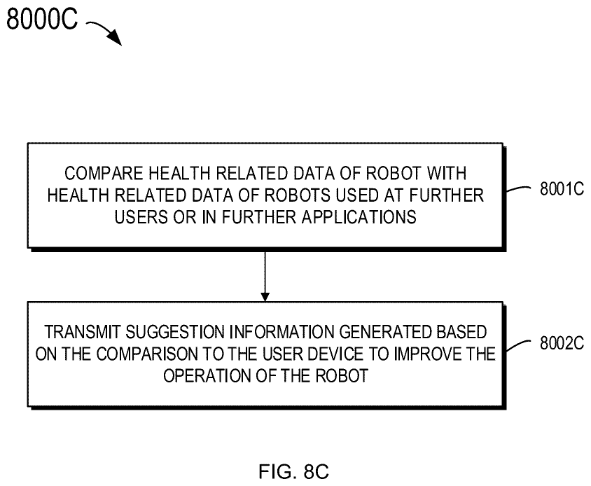

FIG. 8A illustrates a flowchart of procedure 8000A of providing robot fault prediction in accordance with an embodiment of the present disclosure. The procedure 8000A may be implemented by the server 140 as described above.

At block 8001A, the server 140 determines when the robot 110 will fall into an unhealthy state based on the historical information associated with the health condition of the robot 110.

At block 8002A, the server 140 transmits the determined information to the user device 130.

FIG. 8B illustrates a flowchart of procedure 8000B of providing reminder information in the case of no health check for a long time in accordance with an embodiment of the present disclosure. The procedure 8000B may be implemented by the server 140 as described above.

At block 8001B, the server 140 determines a time length since assessment result was last transmitted to the user device 130.

At block 8002B, the server 140 compares the time length with a time threshold.

At block 8003B, if the time length exceeds the time threshold, the server 140 transmits a reminder information to the user device 130.

FIG. 8C illustrates a flowchart of procedure 8000C of providing suggestion information in accordance with an embodiment of the present disclosure. The procedure 8000C may be implemented by the server 140 as described above.

At block 8001C, the server 140 compares health related data of robot 110 with health related data of robots used at further users or in further applications.

At block 8002C, the server 140 transmits suggestion information generated based on the comparison to the user device 130 to improve the operation of the robot 110.

In the embodiments of the present disclosure, the health related data can be transferred from the robot control device to the server in a way of scanning the 2D bar code, which avoids the robot control device from being communicatively connected to external device or networks, thus eliminates sensitive data leakage and other cyber security issues. In addition, the solution of the present disclosure makes the robot system more user-friendly. For example, such robot system can be accepted by small and medium-sized enterprises (SMEs) without or with less digitalization, and more extended services can be provided to the users and improve the user experience. Furthermore, since the assessment criteria does not need to be embedded in the robot controller before the robot product is released to the user, and can be easily refined at the service center, thereby facilitating the reduction of the risk in mis-alarm and false-alarm.

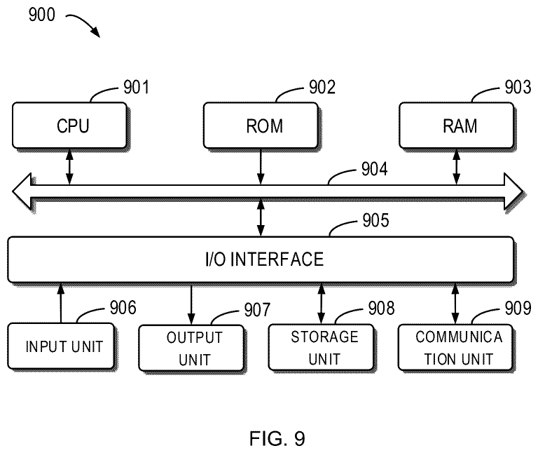

According to other aspects of the present disclosure, an electronic device that can implement embodiments of the present disclosure as mentioned above is provided. FIG. 9 shows a schematic block diagram of an example device 900 adapted to implement embodiments of the present disclosure. For example, the control device 120, the user device 130 and the server 140 may be implemented by the device 900. As shown therein, the device 900 comprises a central processing unit (CPU) 901 that may perform various appropriate actions and processing based on computer program instructions stored in a read-only memory (ROM) 902 or computer program instructions loaded from a storage section 908 to a random access memory (RAM) 903. In the RAM 903, various programs and data needed for operations of the device 900 are further stored. The CPU 901, ROM 902 and RAM 903 are connected to each other via a bus 904. An input/output (I/O) interface 905 is also connected to the bus 904.

The following components in the device 900 are connected to the I/O interface 905: an input unit 906, such as a keyboard, a mouse and the like; an output unit 907, such as various kinds of displays and a loudspeaker, etc.; a memory unit 908, such as a magnetic disk, an optical disk, etc.; a communication unit 909, such as a network card, a modem, a wireless communication transceiver, etc. The communication unit 909 allows the device 900 to exchange information/data with other devices through a computer network such as the Internet and/or various kinds of telecommunications networks.

Various processes and processing described above, e.g., the methods 2000, 4000 and 5000, may be executed by the processing unit 901. For example, in some embodiments, the methods 2000, 4000 and 5000 may be implemented as a computer software program that is tangibly embodied on a machine readable medium, e.g., the storage unit 908. In some embodiments, part or all of the computer programs may be loaded and/or mounted onto the device 900 via ROM 902 and/or communication unit 909. When the computer program is loaded to the RAM 903 and executed by the CPU 901, one or more acts of the methods 2000, 4000 and 5000 as described above may be executed.

According to another aspect of the present disclosure, a computer readable storage medium (or media) having computer readable program instructions thereon for performing aspects of the present disclosure is provided.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the scenario involving the remote computer, the remote computer may be connected to the user's computer through any type of network, including a local area network (LAN) or a wide area network (WAN), or the connection may be made to an external computer (for example, through the Internet using an Internet Service Provider). In some embodiments, the electronic circuitry can be customized by utilizing state information of the computer readable program instructions, for example, programmable logic circuitry, field-programmable gate arrays (FPGA), or programmable logic arrays (PLA). The electronic circuitry may execute the computer readable program instructions, in order to perform aspects of the present disclosure.

Aspects of the present disclosure are described herein with reference to flowchart illustrations and/or block diagrams of methods, device (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can enable a computer, a programmable data processing apparatus, and/or other devices to function in a particular manner, such that the computer readable storage medium having instructions stored therein comprises an article of manufacture, which includes instructions implementing aspects of the function/act specified in block or blocks of the flowchart and/or block diagram.

The computer readable program instructions may also be loaded onto a computer, other programmable data processing apparatuses, or other device to cause a series of operational steps to be performed on the computer, other programmable data processing apparatuses or other devices to produce a computer implemented process, such that the instructions which execute on the computer, other programmable data processing apparatuses, or other devices implement the functions/acts specified in block or blocks of the flowchart and/or block diagram.

It should be appreciated that the above detailed embodiments of the present disclosure are only to exemplify or explain principles of the present disclosure and not to limit the present disclosure. Therefore, any modifications, equivalent alternatives and improvement, etc. without departing from the spirit and scope of the present disclosure shall be comprised in the scope of protection of the present disclosure. Meanwhile, appended claims of the present disclosure aim to cover all the variations and modifications falling under the scope and boundary of the claims or equivalents of the scope and boundary.

1. A method for monitoring health of a robot, comprising:
obtaining measured data associated with health condition of the robot;
generating a 2-dimensional, 2D, bar code based on the measured data, the 2D bar code comprising information associated with the health condition of the robot; and
displaying the 2D bar code on a displayer.

2. The method of claim 1, wherein generating the 2D bar code based on the measured data comprising:
generating, based on the measured data, at least one indicator value at a predefined time interval, the at least one indicator value indicating the health condition of the robot; and
in response to a user request, generating the 2D bar code comprising the latest at least one indicator value.

3. The method of claim 1, wherein the 2D bar code further comprises at least one of identification information of the robot and time information.

4. The method of claim 1, wherein the 2D bar code comprises Quick Response code.

5. A method for monitoring health of a robot, comprising:
scanning a 2-dimensional, 2D, bar code displayed on a displayer of a control device of the robot;
decoding the 2D bar code to obtain information associated with health condition of the robot; and
transmitting the information associated with the health condition of the robot to a server.

6. The method of claim 5, wherein the 2D bar code comprises website information of the server, and
wherein the method further comprises:
accessing the server according to the website information after decoding the 2D bar code.

7. The method of claim 5, further comprising:
receiving assessment result for the health of the robot from the server.

8. A method for monitoring health of a robot, comprising:
receiving information associated with health condition of the robot from a user device;
assessing the health of the robot based on the information associated with the health condition of the robot; and
transmitting the assessment result to the user device.

9. The method of claim 8, further comprising:
determining when the robot will fall into an unhealthy state based on the historical information associated with the health condition of the robot; and
transmitting the determined information to the user device.

10. The method of claim 8, further comprising:
determining a time length since assessment result was last transmitted to the user device; and
in response to the time length exceeding a time threshold, transmitting a reminder information to the user device.

11. The method of claim 8, further comprising:
comparing health related data of robot with health related data of robots used at further users or in further applications, and
transmitting suggestion information generated based on the comparison to the user device to improve the operation of the robot.

12. A control device for a robot, comprising:
a displayer;
a controller, configured to:
obtain measured data associated with health condition of the robot; and
generate a 2-dimensional, 2D, bar code based on the measured data, the 2D bar code comprising information associated with the health condition of the robot; and
display the 2D bar code on the displayer.

13. The control device of claim 12, wherein the controller is further configured to:
determine, based on the measured data, at least one indicator value at a predefined time interval, the at least one indicator value indicating the health condition of the robot; and
in response to a user request, generate the 2D bar code comprising the latest at least one indicator value.

14. The control device of claim 12, wherein the 2D bar code further comprises at least one of identification information of the robot and time information.

15. The control device of claim 12, wherein the 2D bar code comprises Quick Response code.

16. A user device, comprising:
at least one photoelectric sensor configured to scan a 2-dimensional, 2D, bar code displayed on a displayer of a control device for a robot;
at least one processing unit; and
at least one memory coupled to the at least one processing unit and storing instructions executable by the at least one processing unit, the instructions, when executed by the at least one processing unit, causing the device to:
decode the 2D bar code to obtain information associated with the health condition of the robot; and
transmit the information associated with the health condition of the robot to a server.

17. The user device of claim 16, wherein the 2D bar code further comprising website information of the server, and
wherein the instructions, when executed by the at least one processing unit, further causes the device to:
access the server according to the website information after decoding the 2D bar code.

18. The user device of claim 16, wherein the instructions, when executed by the at least one processing unit, further causes the device to:
receive assessment result for the health of the robot from the server.

19. A server, comprising:
at least one processing unit; and
at least one memory coupled to the at least one processing unit and storing instructions executable by the at least one processing unit, the instructions, when executed by the at least one processing unit, causing the server to:
receive information associated with health condition of a robot from a user device;
assess the health of the robot based on the information associated with the health condition of the robot; and
transmit the assessment result to the user device.

20. The server of claim 19, wherein the instructions, when executed by the at least one processing unit, further causing the server to:
determine when the robot will fall into an unhealthy state based on the historical information associated with the health condition of the robot; and
transmit the determined information to the user device.

21. The server of claim 19, wherein the instructions, when executed by the at least one processing unit, further causing the server to:
determine a time length since assessment result was last transmitted to the user device; and
in response to the time length exceeding a time threshold, transmit a reminder information to the user device.

22. The server of claim 19, wherein the instructions, when executed by the at least one processing unit, further causing the server to:
compare health related data of robot with health related data of robots used at further users or in further applications, and
transmit suggestion information generated based on the comparison to the user device to improve the operation of the robot.

23. A health monitoring system for a robot, comprising:
the control device of the robot according to claim 12;
the user device according to claim 16; and
the server according to claim 19.
